(19) United States
(12) Patent Application Publication
(10) Pub. No.: US 2014/0262074 A1
(43) Pub. Date: Sep. 18, 2014

(54) PROCESS FOR SLAT SHAPING AND SHAPED SLATS

(71) Applicant: HAN-SEN LEE, Chang-Hwa Hsien (TW)

(72) Inventor: HAN-SEN LEE, Chang-Hwa Hsien (TW)

(21) Appl. No.: 13/800,901

(22) Filed: Mar. 13, 2013

(51) Int. Cl. E06B 9/386

(52) U.S. Cl. CPC E06B 9/386
USPC 160/236; 156/60

(57) ABSTRACT

A structure and process for making a window covering slat may include a first step in which a matrixed material, preferably a non-woven material, is bonded to a very thin layer of material to form a first bonded member, and forming a second bonded member in a similar way, and joining the first bonded member to a second bonded member using a matrix bonding material, especially under heat and pressure. The ability to produce thin, high-strength window slats having a variety of shapes is realized.

### FIELD OF THE INVENTION

The present invention relates to production methods and products which utilize thin materials, such as wood veneer, in a manner that will provide the ability to mass-produce a superior slat of natural appearance, and a slat construction which utilizes one or more layers of bonding materials, especially thermoplastic materials to join porus structures which give a strength analogous to what would otherwise be utilized as a dependent structural support, and which results in a consistent window slat product which may be flat, curved, or otherwise shaped.

### BACKGROUND OF THE INVENTION

Slats are utilized in a variety of window coverings, including Venetian blinds and vertical blinds. Slats have been constructed of material ranging from thick wood to thin metal from rolls. Wood slats have an advantage of being decorative and sturdy, while metal slats have been more controllable, curved along the path of their shorter dimension to produce a break through stiffness, holding stiff unless stressed. Thinner and thinner wood slats are desired in order to display the visually appealing wood grain, while conserving a volumetric mass of wood which would otherwise go into the making of a slat.

Modern materials and techniques have enabled the construction of slats having a wide variety of strength and size, and other attributes associated with the materials from which they were constructed. However, relatively thin slats made of wood have a tendency to warp and/or have a change in shape or angle of twist along the length of the slat. Various approaches in the past have used a bonding of a wood veneer material onto a metal core in order to have the metal core support the wood veneer layers to resist warping.

The use of a metal core is relatively expensive and can double the cost of slat production, especially after special care is taken to roughen the metal core to facilitate affixation of the application of the wood veneer outer layers. Cost factors dictate the need for a thin, non-warping stable window covering slat. The need for such a thin, non-warping stable window covering slat includes the need for high volume manufacture to reduce the cost. Production methods which are more batch-type can result in an unacceptably high cost. A continuous, highly automated, high quality, mass production method is needed, and one that does not require high rejection rates.

Another problem with wood veneer is making an adequate bond both with the veneer and an underlying structure and between any underlying structures which are used to insure the stability of the slat. Simple gluing may create more quality control problems than it solves. Glue generally must be applied evenly, but where compression of a stack of underlying supports occurs, the glue tends to run to the edge and collect there. Further edge treatment must typically be employed to clean the slat, as well as paint it to hide/disguise the layers. Applying pressure to the layers is another problem as it is required to keep pressure for a long time sufficient for all the glue to dry, or if enough time under pressure is not applied, the layers will resiliently begin to separate and reduce the microscopic contact area.

Another problem involves the inability to produce shape variations without sacrificing either warp control or general planar-based stiffening. Thick slats which have sufficient stiffness, cannot be impressed with a shape. Thin slats, such as those made of metal, can be shaped, but the shaping process can compromise their structural integrity. It is known that metals which are bent will suffer weakness and differential ability to hold outer layers of paint, lacquer and veneer. Further, the ability of a metal support to bend into a desired shape while supporting outer layers of paint, lacquer and veneer is severely limited. In addition, the forces needed to bendably deform a metal support will likely damage any outer layer.

Where a metal support is pre-bent and supplied as a support, other problems of surface treatment arise. Sprayed paint may not cover adequately, and veneers perhaps may not be shapeable to take on the shape of the underlying support. The mismatch in material properties between a strong support and relatively weaker veneers and lacquers almost dictates an expensive and onerous hand production method with high inspection cost for any slat having a holdable support and produced with shape variations.

Efficient manufacturing demands high speed and reliable production techniques which automatically reduce the possibility of introduction of human production error. Continuous manufacturing processes should be configured to intrinsically embody the lowest error rate, while batch manufacturing processes should be configured to be impervious to user introduced handling error. As an example, edge finishing of a slat can create significant error. Where the edge is painted, the flow of paint must be exact and it must be enough cover and yet not so much that it runs onto the face of the slat. Other types of finishing steps for end edges can provide for manufacturing inefficiency and contribute to error rates and scrap.

The central support for any slat represents a major cost component. Metal is expensive, and wood is becoming increasingly scarce. Any technique or structure which can act as a support for any other material in a window covering slat, and which minimizes cost while giving the advantages of strength and stability would be a valuable addition to the slat window covering art. Any support that has a volume that can be minimized to further reduce cost would add greater value. Any support and process which eliminates the need for edge treatment or which facilitates edge finishing would also be of benefit.

### SUMMARY OF THE INVENTION

The structures and process for making a window covering slat of higher quality at lower cost can also involve the ability to produce stable shape variations with very little additional effort. The attachment and bonding of the layers involves a first step in which a matrixed material, preferably a non-woven material (especially where significant thinness is desired) is bonded to a very thin layer of material which is to be a layer having one side which may likely be an exposed, decorative layer which will occupy a first main side of the resulting slat 21.

A second step in which a matrixed material, which may also preferably be a non-woven material (especially where significant thinness is desired) is bonded to a very thin layer of material which is to be a layer having one side which may likely be an exposed, decorative layer which will occupy a second main side of the resulting slat. In a third step, the bonded member from step one has its matrixed material arranged and oriented to face a matrixed material of the bonded member from step two and the matrixed materials of the bonded members are bonded to each other using matrix bonding material which may or may not, for simple constructions form, along with the volume of the matrix materials infused, a main support.

Bonding of the matrixed materials of the bonded members to each other can be accomplished with a matrix bonding material which can infuse the matrixed materials, especially under the influence of heat and pressure, to form and to help the matrixed materials form a structural support. The bonding of matrixed materials to each other with the matrix bonding material causes the two members which were previously bonded only to their matrix layers, to form a window covering slat. The two members which were previously bonded only to their matrix layers, can form the window covering slat even when pressed together in a press which can also add a shape to the window covering slat thus formed. In some cases, the matrix bonding material can be chosen for properties ranging from only an infusion and thermoplastic characteristic, to properties of pure adhesion to the matrix materials (which include cloth or nonwoven material). The type of matrix bonding material chosen will depend upon the type of matrix materials chosen.

Because of the resulting thinness of the window covering slat, further finishing and trimming of the edges can be accomplished in a driven conveyor trimmer which will facilitate a more precise control of edge treatment. Edge treatment can include trimming, staining, abrasive sanding, or extrusive scraping. In addition, other continuous treatment processes including stamping and punching can be facilitated, either before or after joining of the two members which were previously bonded only to their matrix layers.

Shapes which are impressed into the two members which were previously bonded only to their matrix layers, to form a completed slat can occur either before or after formation of the window covering slat in a press, but may preferably be shaped at the time of formation of the window covering slat in a press. Where a shape is desired which has a constant shape along the length of the resulting pressed window covering slat, the process of joining, bonding and pressing can occur continuously in a driven conveyor system. The formation of the shape can be achieved by a shaping die, with heat application by the use of a heated wheel. In the alternative, and especially where the veneer layer may be uneven, the formation of the shape can be achieved by pressing each individual completed slat after formation of the window covering slat, or before formation of the completed window covering slat, such as by impressing the two members which were previously bonded only to their matrix layers.

The material used to bond a very thin layer of material to a matrixed and preferably perhaps a non-woven “fabric” or “porus” type material, to form a bonded member, and the material used to bond together two bonded members into a window covering slat may include thermoplastic bonding material utilized under heat so that such bonding material infuse non-woven, “fabric”, or other “porus” type material to combinably form a support which will resist deformation and twisting. Attachment and further treatment of either the bonded member or the window covering slat may involve other processing steps including trimming and compressing any edges of either the bonded member or the window covering slat. The bonding materials can be applied and controlled in any manner including spray, wiping, heat and more.

### BRIEF DESCRIPTION OF THE DRAWINGS

The invention, its configuration, construction, and operation will be best further described in the following detailed description, taken in conjunction with the accompanying drawings in which:

FIG. 1 illustrates a perspective exploded schematic view of the an end of a series of materials which illustrates the overall orientation of layers and bonding materials;

FIG. 2 illustrates a schematic drawing illustrating a possible separate first step in which a matrixed, perhaps non-woven material is bonded to a very thin layer of material which is to be a layer having one side which may likely be an exposed, such as a decorative layer and which may be a continuous process to form a first bonded member as half of the structures needed to form a slat not counting a final middle bonding material;

FIG. 3 illustrates a schematic drawing of a potential final processing step in which two bonded materials have a bonding material formulated to glue, infuse and join a pair of bonded members under pressure and heat to form a final window covering slat;

FIG. 4 illustrates an end view of a slat having a middle width portion, a first angled portion at an angle of from about 40-60 degrees from middle width portion, and a second angled portion at an angle of from about 70-80 degrees from middle width portion;

FIG. 5 illustrates an end view of a slat having a main width portion and a single angled portion having an angle of from about 40-60 degrees from the main width portion;

FIG. 6 illustrates an end view of a slat having a middle width portion, a first downwardly angled portion at an angle of from about 40-70 degrees from middle width portion 123, and a second, but upwardly angled portion 127 at an angle of from about 40-70 degrees from middle width portion;

FIG. 7 illustrates an end view of a slat having an overall “S” shape including a first radiused surface joined to a second radiused surface through a transition surface which may include some flat extent;

FIG. 8 illustrates an end view of a slat having a main gently curved width portion and may have a sharper curvature portion adjacent end edges; and

FIG. 9 illustrates an end view of a slat having a flat planar portion as an example of the most basic, generally flat planar type of slat formable by the inventive process herein.

### DETAILED DESCRIPTION OF THE PREFERRED EMBODIMENT

The description and operation of the veneer system and method of the invention will be best described with reference to FIG. 1 which illustrates a perspective exploded schematic view of the an end of a series of materials which illustrates the overall orientation of layers and bonding materials to form a window covering slat 21, and which may be thought of as an exploded view of a window covering slat 21.

At the top of FIG. 1, a first very thin layer of material 23 is shown which may be a first layer of material 23 having one side 25 (upwardly oriented and indicated with an arrow) which may likely be an exposed, decorative layer of the window covering slat 21 and which will occupy a first main side of the resulting slat. Where first layer of material 23 is made of a thin wood veneer, the side 25 may well be finished to a matte or glossy finish and stained to show the wood grain pattern to a desired effect. Window covering slat 21 may also be finished after it is assembled, or subjected to further processing operations after assembly, including single and group processing.

Also at the top of FIG. 1, a bonding side 27 of very thin layer of material 23 is shown. Bonding side 27 may have a surface which is treated to maximize a holding bond with any bonding material. Below bonding side 27, a first layer of bonding material 31 is seen. Bonding material 31 can be realized in any form of any material which has the ability to bond with bonding side 27 of very thin layer of material 23. The bonding material 31 will be chosen to be compatible with the finish given to the surface of the bonding side 27.

Seen to the other side of the bonding material 31 is a first matrixed and preferably perhaps a non-woven “fabric” or “porus” type material 33 which should easily bond to the bonding material 31 both by gluing and partially by infusion into and around the structural members of the non-woven type material 33. The joining together of the first very thin layer of material 23, and the first matrixed and preferably perhaps a non-woven “fabric” or “porus” type material 33 with first layer of bonding material 31, forms a first bonded member 35.

Referring to the bottom of FIG. 1, a second very thin layer of material 43 is shown which may be a second layer of material 43 having one side 45 (downwardly oriented) which may likely be an exposed, decorative layer of the window covering slat 21 and which will occupy a second main side of the resulting slat 21. Where second layer of material 43 is made of a thin wood veneer, the side 45 may well be finished to a matte or glossy finish and stained to show the wood grain pattern to a desired effect. Second layer of material 43 may be the same as or different than first layer of material 23.

Also near the bottom of FIG. 1, a bonding side 47 (indicated with an arrow) of very thin layer of material 43 is shown. Bonding side 47 may have a surface which is treated to maximize a holding bond with any bonding material. Above bonding side 47, a second layer of bonding material 51 is seen. Bonding material 51 can be realized in any form of any material which has the ability to bond with bonding side 47 of very thin layer of material 43. The bonding material 51 will be chosen to be compatible with the finish given to the surface of the bonding side 27. Bonding material 51 may or may not be identical to bonding material 31, and may be selected based upon the materials used for first and second very thin layers of material 23, 43, as well as the texture and preparation of the bonding surfaces 27, 47.

Seen to the other side of the bonding material 51 is a second matrixed and preferably perhaps a non-woven “fabric” or “porus” type material 53 which should easily bond to the bonding material 51 both by gluing and partially by infusion into and around the structural members of the non-woven type material 53. First matrixed and preferably perhaps a non-woven “fabric” or “porus” type material 33 may or may not be the same type of material as second matrixed and preferably perhaps a non-woven “fabric” or “porus” type material 53. The joining together of the second very thin layer of material 43, and the second matrixed and preferably perhaps a non-woven “fabric” or “porus” type material 53 with second layer of bonding material 51, forms a second bonded member 55.

The centermost layer of the layers shown in FIG. 1 is a matrix bonding material 61 shown at the center of the layers seen below and above. Matrix bonding material 61 may have some adhesive and some thermoplastic properties. The matrix bonding material 61 will preferably be infused into both the first and second matrixed and preferably perhaps a non-woven “fabric” or “porus” type materials 33, 53 to join the first bonded member 35 to the second bonded member 55 to form the window covering slat 21.

The thickness and properties of materials 33, 53 and the volume of matrix bonding material 61 will determine the extent that the matrix bonding material 61 can infuse into the materials 23, 53. Some of these properties will include wicking, viscosity, and co-bonding. The matrix bonding material 61 may be, in some cases, identical to the first and second layers of bonding material 31, 51. The volumes of the matrix bonding material 61 and first and second layers of bonding material 31, 51 may be controlled to prevent overflow, and to take advantage of any bonding of matrix bonding material 61 and first and second layers of bonding material 31, 51 to each other should such occur.

As such, any infusion of the first layer of bonding material 31 into a portion of the thickness of the first matrixed and preferably perhaps a non-woven “fabric” or “porus” type material 33 needs to be controlled to leave sufficient remaining thickness of material 33 for infusion of the matrix bonding material 61. The same is true for second matrixed and preferably perhaps a non-woven “fabric” or “porus” type material 53, that it needs to be controlled to leave sufficient remaining thickness of material 53 for infusion of the matrix bonding material 61.

Referring to FIG. 2, a schematic diagram illustrates a first step in which a matrixed, perhaps non-woven material 33 is bonded to a first very thin layer of material 23 in what may be a continuous manufacturing process. The illustrated example, for simplicity will relate to the top or first three structures seen at the top of FIG. 1 as an example, and may be equivalent to a process for the bottom or last three structures seen in FIG. 1. In FIG. 2, a first very thin layer of material 23 is shown entering from the left. Although shown as a continuous line, it may be necessary to have processes and/or workers upstream to perform a number of steps related to quality control, interfitting non-continuous veneer lengths together, performing a shaving operation where veneer is separated from a block of wood and/or trimmed into lengths of narrower width, treated with lacquer, has its bonding side 27 prepared for bonding, and other process steps not shown.

FIG. 2's schematic diagram is a side view and thus can operate in wider sheets of the first very thin layer of material 23 where it is desired to perform a trimming/cutting operation later on. The continuation of the descriptions will assume that the process is acting to join the first three structures in FIG. 1 to form a width which approximates a slat width to form a first bonded member 35 having an approximate width of a slat.

At the lower left side of FIG. 2, first very thin layer of material 23 comes into view, and may likely be supplied in the form of a large roll of material to enable continuous processing. A spray nozzle 71 may supply and apply the first layer of bonding material 31 directly onto either the bonding side 27 of the first layer of bonding material 31 or to the first matrixed and preferably perhaps a non-woven “fabric” or “porus” type material 33. In FIG. 2, the first layer of bonding material 31 is applied directly onto the first matrixed and preferably perhaps a non-woven “fabric” or “porus” type material 33 and may be formulated to somewhat control and possibly limit the extent to which the thickness of the material 33 is penetrated by the first layer of bonding material 31. Where a solvent is used as a carrier, the appropriate evaporation, temperature and atomization can be formulated to achieve such penetration control.

At an appropriate point, one or more guide drums 73 and 75 will guide the first very thin layer of material 23 and the first matrixed and preferably perhaps a non-woven “fabric” or “porus” type material 33 into close contact and possibly compressing the first layer of bonding material 31. The partially compressed materials 23 and first matrixed and preferably perhaps a non-woven “fabric” or “porus” type material 33 may have enough cohesion to stay together, and may have formed the first bonded member 35, but may not yet have the internal strength needed without further processing.

The next process step can be performed continuously or in a batch manner. One possibility for continuous processing is the use of a pair of possibly driven hot, high pressure rollers 77 and 79. Where it is desired to use high pressure rollers 77 and 79 at the stage of formation of the first bonded member 35, the high pressure rollers 77 and 79 may have a simple cylindrical shape and may not necessarily impress a shape upon the resulting first bonded member 35. Much of the decision to use high pressure rollers 77 and 79 at the process point of formation of the first bonded member 35, rather than later at the point of formation of the window covering slat 21. The decision as to when to perform final shape impressment and final bonding will depend upon the shape, the type of material used for first and second layer of bonding materials 31, 51, and the generally central (though it need not be) matrix bonding material 61.

Referring to FIG. 3 a potential final processing step in which first and second bonded materials 35 and 55 are joined using matrix bonding material 61 as an example of one type of final processing. At the left side of FIG. 3, a line of first bonded material 35 is seen entering and preferably configured so that its first matrixed and preferably perhaps a non-woven “fabric” or “porus” type material 33 is oriented facing a line of second bonded material 55. A line of second bonded material 55 is seen entering and preferably configured so that its second matrixed and preferably perhaps a non-woven “fabric” or “porus” type material 53 is oriented facing toward the line of first bonded material 33. A nozzle 81 is shown producing a spray of matrix bonding material 61 which simply happens to have been applied to first bonded material 35. The matrix bonding material 61 can be applied in any form or technique, such as by a film or drizzle or spray. Any application technique will depend upon the form of the matrix bonding material 61 and its bonding action.

The first and second bonded materials 35 and 55 are shown as converging through a gentle taper, as may be the case where first and second bonded materials 35 and 55 are relatively stiff or for other reasons should not be bent (which will in turn depend upon their materials of construction). A number of opposing high pressure rollers, schematically represented by high pressure rollers 83 and 85 apply heat to the first and second bonded materials 35 and 55 to form window covering slat 21. The amount of heat, the amount of residence time that matrix bonding material 61 is under the influence of the heat, the amount of capacity of the first and second layer of bonding material 31 and 51 to absorb and bond with the matrix bonding material 61 are factors which dictate the heating configuration.

High pressure rollers 83 and 85 may be assisted by other methods for injecting heat into the matrix bonding material 61 including the inputting of ultrasonic energy, microwaves, radio waves, and radiant pre-heating of the matrix bonding material 61 before the first and second bonded materials 35 and 55 are brought together and physically force pressured. The matrix bonding material 61 may also be applied hot and immediately before high pressure rollers 83 and 85 act to cause the first and second bonded materials 35 and 55 to fuse and form the window covering slat 21.

High pressure rollers 77, 79, 83, and 85 may be used to impress a shape in the resulting window covering slat 21. If done as a continuous rolling process, the shape will likely have a constant cross sectional area, or at least a repeating pattern where the shape of the high pressure rollers 77, 79, 83, and 85 is used to make an impressed extrusion, especially at a temperature of several hundred degrees above zero Fahrenheit. It is understood that any shape can be impressed by a heated press, and that heat is especially helpful where the matrix bonding material 61 has thermoplastic properties.

Referring to FIGS. 4-9, a series of shapes which can be produced with the process for making the window covering slat 21. These shapes are taken from a position looking from the end along the length of a slat. FIG. 4 illustrates an end view of a slat 101. Slat 101 has a middle width portion 103, a first angled portion 105 at an angle of from about 40-60 degrees from middle width portion 103, and a second angled portion 107 at an angle of from about 70-80 degrees from middle width portion 103. The shape of slat 101 enables a greater degree of light blocking even when the middle width portion 103 of slat 101 is horizontal and therefore not in an angular closed position.

Referring to FIG. 5, a slat 111 has a main width portion 113, and a single angled portion 115 at an angle of from about 40-60 degrees from the main width portion 113. The shape of slat 111 enables a greater degree of light blocking even when the slat is in an angular closed position over that which would occur as compared to a flat slat. Further, slat 111 will tend to block some low angle light, even when a window covering set is in an open position where the main width portion 113 is horizontal. Referring to FIG. 6, a slat 121 has a middle width portion 123, a first downwardly angled portion 125 at an angle of from about 40-70 degrees from middle width portion 123, and a second, but upwardly angled portion 127 at an angle of from about 40-70 degrees from middle width portion 123. The shape of slat 121 enables some light blocking angular cover when a window covering set of slats is oriented to a closed position.

Referring to FIG. 7, a slat 131 has an overall “S” shape including a first radiused surface 133 joined to a second radiused surface 135 through a transition surface 137 which may include some flat extent. When the slat 131 is moved so that second radiused surface 135 is below transition surface 137 and that first radiused surface 133 is above transition surface 137, there may be a greater degree of overlap of an edge closer to first radiused surface 133 which may somewhat overlap an edge closer to first radiused surface 135. However, where slat 131 is tilted to a position such that first radiused surface 135 is at maximum height, interesting and aesthetically pleasing light patterns can occur, and a set of slats 131 will give a marked appearance noticeably different than an appearance of a conventional slat set.

Referring to FIG. 8, a slat 141 has a main gently curved width portion 143, and may have a sharper curvature portion 145 adjacent end edges 147. Sharper curvature portion 145 can, depending upon the materials chosen, provide a different more light rejecting capture effect when a window covering set having slats 141 is in the closed position. Referring to FIG. 9, a slat 121 has a flat planar portion 153. Slat 121 is the most basic, generally flat planar type of slat and can be made using the process described herein.

While the present invention has been described in terms of a system and method for forming of various constructions of slats and shapes of slate from very thin layers of material, one skilled in the art will realize that the structure and techniques of the present invention can be applied to many structures, including any structure or technique where the material used to join formed bonded members forms a significant portion of the main support.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A slat for a window covering comprising:
a first very thin layer of material having a first, decorative side and a second side having a bonding surface;
a first layer of bonding material bonded to the second bonding side of the first very thin layer of material;
a first matrixed material partially infused with the first layer of bonding material and affixed to the first very thin layer of material; the first very thin layer of material, first layer of bonding material and first matrixed material forming a first bonded member;
a second very thin layer of material having a first, decorative side and a second side having a bonding surface;
a second layer of bonding material bonded to the second bonding side of the second very thin layer of material;
a second matrixed material partially infused with the second layer of bonding material and affixed to the second very thin layer of material; the second very thin layer of material, second layer of bonding material and second matrixed material forming a second bonded member;
a matrix bonding material at least partially infused into both the first and the second matrixed materials joining and giving strength to a window covering slat formed from attachment of the first bonded member and the second bonded member.

2. The slat for a window covering as recited in claim 1 wherein the matrix material is a non-woven material.

3. The slat for a window covering as recited in claim 1 wherein the first very thin layer of material is a wood veneer material.

4. The slat for a window covering as recited in claim 1 wherein the matrix bonding material is a thermoplastic material.

5. A process for producing a slat for a window covering comprising the steps of:
providing a first very thin layer of material having a first, decorative side and a second side having a bonding surface;
providing a first matrixed material having a first side and a second side;
applying first layer of bonding material to and partially between the second bonding side of the first very thin layer of material and the first side of the first matrixed material, and bonding the first layer of bonding material to the first very thin layer of material to form a first bonded member;
providing a second very thin layer of material having a first, decorative side and a second side having a bonding surface;
providing a second matrixed material having a first side and a second side;
applying second layer of bonding material to and partially between the second bonding side of the second very thin layer of material and the second side of the second matrixed material, and bonding the second layer of bonding material to the second very thin layer of material to form a second bonded member;
applying a matrix bonding material to the second sides of the first and second matrixed material to infuse through the second sides of the first and second matrixed material and join the first bonded member to the second bonded member at the second sides of the first and second matrixed material to form a window covering slat.

6. The process for producing a slat for a window covering as recited in claim 5 wherein the steps of production of the first bonded member is performed in a continuous process.

7. The process for producing a slat for a window covering as recited in claim 5 wherein the matrix bonding material is heated.

8. The process for producing a slat for a window covering as recited in claim 5 wherein the matrix bonding material is heated after joining of the first bonded member to the second bonded member.

9. The process for producing a slat for a window covering as recited in claim 5 wherein the matrix bonding material is heated by a hot pressure roller.

10. The process for producing a slat for a window covering as recited in claim 5 wherein the bonding of the first layer of bonding material to the first very thin layer of material to form a first bonded member step is performed by compressing the first layer of bonding material between the first matrixed material and the first very thin layer of material.

11. The process for producing a slat for a window covering as recited in claim 5 wherein the bonding of the first layer of bonding material to the first very thin layer of material to form a first bonded member step is performed by heating and compressing the first layer of bonding material between the first matrixed material and the first very thin layer of material.

12. The process for producing a slat for a window covering as recited in claim 5 wherein the first bonded member is identical to the second bonded member.

13. The process for producing a slat for a window covering as recited in claim 5 wherein the first matrixed material, second maxtrixed material and matrix bonding material are identical.

14. The process for producing a slat for a window covering as recited in claim 5 wherein the first very thin layer of material is different than the second very thin layer of material.
